(19) United States
(12) Patent Application Publication
(10) Pub. No.: US 2026/0025484 A1
(43) Pub. Date: Jan. 22, 2026

(54) IMAGE RECORDING DEVICE AND MEDIUM

(71) Applicant: HONDA MOTOR CO., LTD., Tokyo (JP)

(72) Inventors: Srinivasa Divakar BHAT, Wako-shi (JP); Prateek GARG, Wako-shi (JP); Mudit SONI, Wako-shi (JP); Tarun SATHESH, Wako-shi (JP); Surbhi AGRAWAL, Wako-shi (JP); Akira KANEHARA, Wako-shi (JP); Masamitsu TSUCHIYA, Wako-shi (JP); Ryuji IWASHITA, Wako-shi (JP)

(73) Assignee: HONDA MOTOR CO., LTD., Tokyo (JP)

(21) Appl. No.: 19/341,061

(22) Filed: Sep. 26, 2025

Related U.S. Application Data
(63) Continuation of application No. PCT/JP2023/013630, filed on Mar. 31, 2023.

(51) Int. Cl. H04N 7/18; B60R 1/24; B60R 1/26; H04N 5/76; H04N 23/667; H04N 23/695; H04N 23/90

(52) U.S. Cl. CPC H04N 7/181; B60R 1/24; B60R 1/26; H04N 5/76; H04N 23/667; H04N 23/695; H04N 23/90; B60R 2300/105

(57) ABSTRACT

An image recording device capable of being retrofitted to a vehicle has a fixing member configured to be fixed to the vehicle; a main body fixed to the vehicle by the fixing member; at least one camera provided in the main body and configured capture an image in surroundings of the vehicle; an adjuster configured to adjust an attitude of the main body; an output unit configured to output the image captured by the at least one camera to a display. The image recording device performs processing including, in a case where an adjustment mode is designated, causing the output unit to output another image obtained by synthesizing a reference image with the image captured by the at least one camera, a position of the reference image with respect to a frame of the image being fixed.

### CROSS-REFERENCE TO RELATED APPLICATION(S)

This application is a Continuation of International Patent Application No. PCT/JP2023/013630, filed Mar. 31, 2023, which is hereby incorporated by reference herein in its entirety.

### BACKGROUND OF THE INVENTION

### Field of the Invention

The present disclosure relates to an image recording device and a medium that are attached to, for example, a vehicle and that record a surrounding image.

### Description of the Related Art

There is a device known as a dashcam that is installed in a vehicle and that has a function of capturing an image of the exterior of the vehicle and recording the latest image for a predetermined period of time. Some dashcams have a function for driving assistance (for example, Japanese Patent Laid-Open No. 2019-8777). Japanese Patent Laid-Open No. 2019-8777 describes that a dashcam detects an inter-vehicle distance to a vehicle traveling ahead, and issues a warning upon detection that the vehicle is in a proximity state.

When the distance to a surrounding object, for example, a preceding vehicle is measured from an image as described in Japanese Patent Laid-Open No. 2019-8777, it is difficult to measure the distance accurately, unless a camera is attached at a predetermined position in a predetermined attitude. For this reason, if the camera is attached as a part of the vehicle at the time of manufacture, it is considered that the attachment accuracy is high and the accuracy in monitoring the surroundings is also high. On the other hand, it is difficult to accurately retrofit a vehicle body with the dashcam at a predetermined position and in a predetermined attitude. Although trying to perform the driving assistance such as monitoring the surroundings, it is difficult to achieve it with high accuracy.

### SUMMARY OF THE INVENTION

The present disclosure has been made in view of the above conventional example, and an image recording device to be retrofitted to a vehicle is attached in a predetermined attitude with high accuracy.

According to one aspect of the present disclosure provides an image recording device capable of being retrofitted to a vehicle, the image recording device comprising: a fixing member configured to be fixed to the vehicle; a main body fixed to the vehicle by the fixing member; at least one camera provided in the main body and configured to capture an image in surroundings of the vehicle; an adjuster configured to adjust an attitude of the main body; an output unit configured to output the image captured by the at least one camera to a display; at least one memory storing instructions; and at least one processor that is in communication with the at least one memory and that, when executing the instructions, cooperates with the at least one memory to execute processing, the processing including in a case where an adjustment mode is designated, causing the output unit to output another image obtained by synthesizing a reference image with the image captured by the at least one camera, a position of the reference image with respect to a frame of the image being fixed.

According to the above configuration, the image recording device to be retrofitted to the vehicle is attachable in a predetermined attitude with high accuracy.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a view illustrating a vehicle according to an embodiment;

FIG. 2 is a block diagram of a dashcam according to an embodiment;

FIG. 3 is an external view of the dashcam according to an embodiment;

FIG. 4 is a flowchart of display processing by the dashcam according to an embodiment at the time of attachment;

FIG. 5 is a flowchart of camera switching processing by the dashcam according to an embodiment at the time of attachment; and

FIG. 6 is a diagram illustrating a display example by the dashcam according to an embodiment at the time of attachment.

### DESCRIPTION OF THE EMBODIMENTS

### First Embodiment

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The present embodiment relates to an image recording device for recording an image in the surroundings of a moving body to which the image recording device is attached. Such an image recording device may have a function of monitoring the surroundings, based on a captured image, and issuing a warning to the driver as necessary. In the following embodiments, description will be made with an example in which the image recording device is, for example, a dashcam attached to a moving body such as a vehicle. However, the image recording device may be any other device, as long as it is attached to a moving body and is capable of capturing images of the interior and the exterior of the moving body. Also in the following embodiments, description will be made with an example in which the moving body is, for example, a vehicle. The vehicle is typically a four-wheeled vehicle, but the following embodiments may be applied to any other type of vehicle, as long as the vehicle is driven and operated by an occupant.

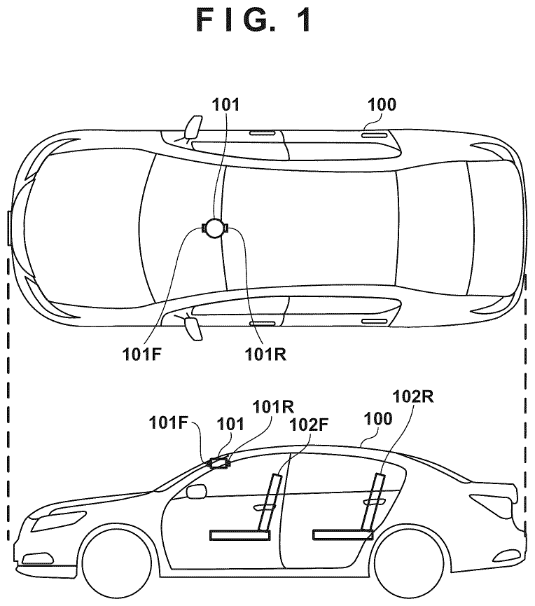

An example of a position to which the dashcam is attached will be described with reference to FIG. 1. A dashcam 101 is attached to a vehicle 100. The dashcam 101 is attached to a position, which does not obstruct the driver's field of view, on a windshield of the vehicle 100, and which is either in the vicinity of a rear-view mirror of the vehicle 100 or on the rear-view mirror. The attachment position of the dashcam 101 is not limited to such a position, and may be any position, as long as it is capable of capturing an image of the external view of the vehicle 100.

Although the dashcam 101 is capable of operating on a stand-alone basis, the dashcam 101 may receive electric power supplied from the vehicle 100. The dashcam 101 includes: a front-view camera 101F, which captures an image of the exterior of the vehicle, in particular, a scene on a forward side of the vehicle; and a rear-view camera 101R, which captures an image of the interior of the vehicle and the exterior of the vehicle from a side window or a rear window through the interior of the vehicle. The rear-view camera 101R is capable of capturing an image including at least upper portions of a front seat 102F and a rear seat 102R.

### Configuration Example of Dashcam

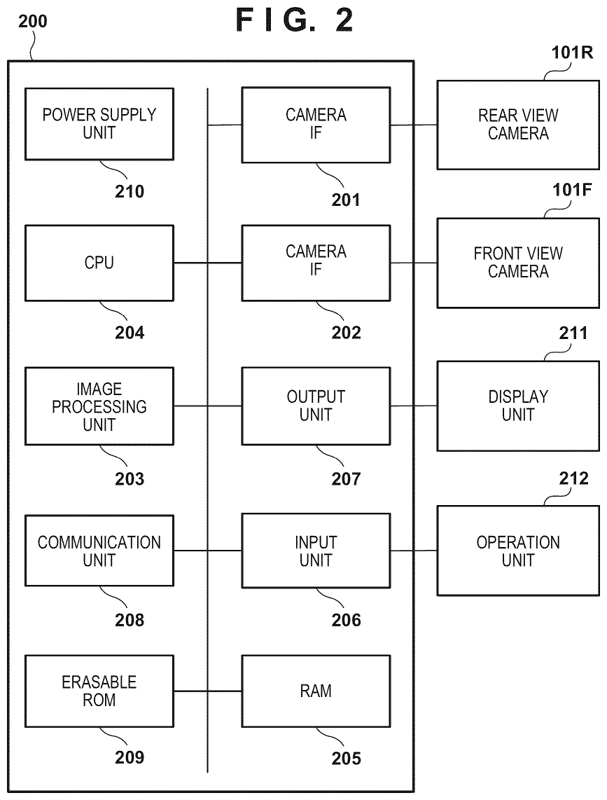

FIG. 2 illustrates an example of a control configuration of the dashcam 101 according to an embodiment. Such a dashcam is retrofitted to the vehicle, and it is sufficient without an input signal from the outside. However, the supply of electric power to the dashcam 101 relies on the vehicle 100. Also for a user interface, any device mounted on the vehicle 100 or any other device can be used. It is needless to say that the dashcam 101 may include an input and output device for providing the user interface. In the present embodiment, the dashcam monitors the surroundings of the vehicle. By focusing on such a fact, the dashcam 101 will be referred to as a surroundings monitoring device or a driving assistance device, in some cases.

In FIG. 2, the dashcam 101 includes a controller 200, the rear-view camera 101R, and the front-view camera 101F. Each of these cameras will be referred to as an imaging unit or an image acquisition unit, in some cases. Camera interfaces (IFs) 201 and 202 are signal interfaces respectively for the rear-view camera 101R and the front-view camera 101F. Each camera captures a video (a moving image) at a predetermined frame rate of, for example, 29 frames per second (fps). The captured image is subjected to image processing by an image processing unit 203, and is further subjected to necessary processing by a central processing unit (CPU) 204. Then, the captured image is stored as a video file in an erasable read-only memory (ROM) 209. A video file includes a video of a predetermined period of time, for example, about 30 seconds to 60 seconds. When recording for the predetermined period of time is finished, a new video file is recorded. There are at least two video files. When there is no free space in the erasable ROM 209, the oldest video file is erased to ensure free space, and a new video file is recorded in such a space. In addition, it is possible to refer to the captured video for every frame, and in the present example, the frame will be particularly referred to as an image, in some cases. Note that the processing that can be performed by the image processing unit 203 may include, for example, processing of converting an image obtained by capturing an object into an image in which the angle at which the object is viewed is changed, for example, projective transformation. In addition, the CPU 204 executes a program of a procedure to be described later, and incorporates a timer, not illustrated.

In order to fulfill the function as a dashcam, the dashcam also includes an acceleration sensor or the like, and may conduct control of stopping recording a video file upon detection of acceleration that exceeds a predetermined value.

A communication unit 208 provides a wired or wireless communication function. For example, via the communication unit 208, a connection may be established with a mobile terminal such as a smartphone to display an image. It is also possible to perform communication for any other purpose.

An input unit 206 and an output unit 207 each include an input and output unit as the user interface. The input and output unit may be implemented by, for example, a touch panel that constitutes an operation unit. Alternatively, an interface for connecting with a display audio device provided in the vehicle 100 may be provided. In FIG. 2, the input unit 206 is connected with an operation unit 212, and then it becomes possible to perform an operation. In addition, the output unit 207 is connected with a display unit 211, and the display unit 211 is capable of displaying. The display unit 211 may be provided separately from the main body of the dashcam 101. A random access memory (RAM) 205 is used as a data memory necessary for the operations by the CPU 204 and the image processing unit 203 and as a memory for storing a program to be executed on the CPU 204. A power supply unit 210 is connected with the power supply provided from the vehicle 100, and supplies electric power suitable for the dashcam.

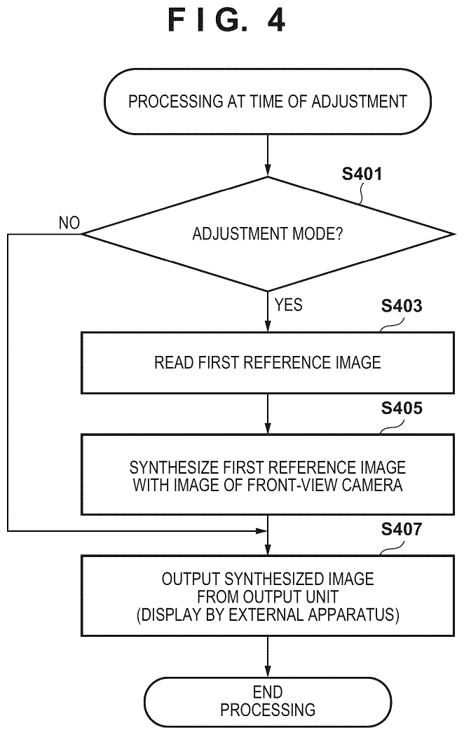

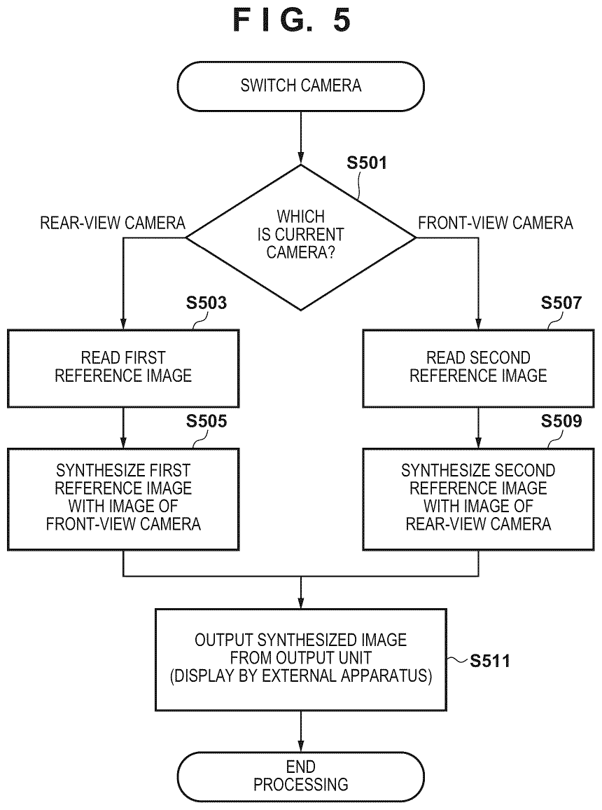

Furthermore, the dashcam 101 has a driving assistance function achieved by executing a program on the CPU 204 in addition to the function as the dashcam. The driving assistance function includes a function of measuring a distance to a target object in the surroundings of the vehicle, for example, a preceding vehicle, a pedestrian, another vehicle, or a building, and a traveling speed of the vehicle 100, and issuing a warning if the vehicle approaches too close to the target object. Furthermore, as illustrated in FIGS. 4 and 5 to be described later, it is possible to display a screen for adjusting the attitude of the dashcam 101 at the time of attachment.

### Configuration of Dashcam

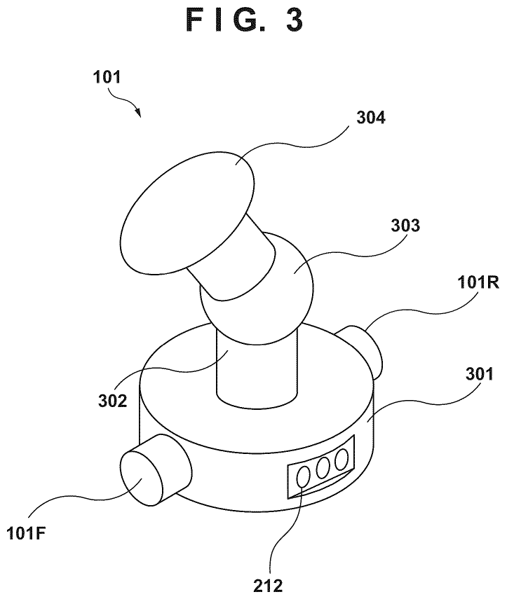

FIG. 3 is a perspective view of the dashcam 101. The dashcam 101 includes a main body portion 301, in which the front-view camera 101F and the rear-view camera 101R are integrally provided. The front-view camera 101F and the rear-view camera 101R are fixed to the main body portion 301, and their optical axes coincide with each other in the present example. The operation unit 212 is also provided on the main body portion 301. In the present example, the operation unit 212 includes buttons including a power button and an adjustment mode button. The main body portion 301 is attached to a support member 302, which is provided on the main body portion 301. The support member 302 includes an adjustment portion 303 for adjusting the attitude of the main body portion 301, and an attachment portion 304 to be attached to the vehicle main body is provided at an end portion opposite to the main body portion 301. The attachment portion 304 may be, for example, a sucker to be attached to the windshield. In addition, the adjustment portion 303 is capable of adjusting the inclination, for example, around three axes orthogonal to one another in order to adjust the attitude of the main body portion 301, and is capable of maintaining the attitude after adjustment. It is sufficient if the user is able to manually adjust the attitude.

### Attachment of Dashcam and Adjustment of Attitude

Ideally, the main body portion 301 is installed so that at least the front-view camera 101F is not inclined. Not being inclined denotes while the vehicle 100 is in a horizontal state, the optical axis of the front-view camera 101F is parallel to the ground surface, the optical axis is directed to a forward side of the vehicle 100, and the scanning line of the frame of the captured image is horizontal. It is desirable to adjust the attitude of the main body portion 301 to be fixed to the vehicle 100 in such a manner. The adjustment in such a manner is desirable because the dashcam 101 needs to learn the position and the attitude of the camera beforehand in order to identify the position in a three-dimensional space of a subject in the exterior of the vehicle from the captured image. For example, in a case where the camera is fixed to the vehicle 100 in the ideal state as described above, it becomes possible to estimate the position in the three-dimensional space of the target object, which is the subject, from the image. In addition, even though the camera is not attached in an ideal state, learning of a difference in position and attitude from such a state makes it possible to compensate the position of the target object through coordinate conversion in accordance with such a difference.

Hence, in order to attach the dashcam 101 to the vehicle in the above-described ideal state or in a state more similar to such an ideal state, an image-captured scene of the exterior of the vehicle and a reference image are synthesized together and then displayed at the time of camera adjustment. By referring to such an image and making an adjustment, the user who adjusts the attitude of the main body portion 301 is able to adjust the main body portion 301 for a more ideal attitude. The adjustment may be made in such a manner that, for example, after the dashcam 101 is attached to the vehicle 100, the user holds the main body portion 301, releases a fixing mechanism, if any, of the adjustment portion 303, then sets the main body portion 301 to a desired attitude, and fixes it again with the fixing mechanism. Note that at the time of adjustment, the display is performed as will be described later. Thus, at the time of attachment, after the connection with a power supply is established, the adjustment has to be made.

Note that when the dashcam 101 is attached to the vehicle 100, its position is input by the user. Its position includes at least a height from the ground surface or information with which the height is identifiable. Furthermore, an offset from the center in the width direction of the vehicle to the attachment position of the main body portion 301 may be included. In a case where the main body portion 301 (that is, the cameras) is horizontal and the height from the ground is learned, it is possible to identify the distance to the position identified on the ground surface in a captured frame from an image height in the frame (for example, a height from a frame lower side). In addition, in a case where the offset from the center in the width direction of the vehicle to the attachment position of the main body portion 301 is set, it becomes possible to perform, for example, coordinate conversion of performing parallel translation of the optical axis of the camera into the center line in the width direction of the vehicle, and it becomes possible to identify the position in the vehicle width direction with higher accuracy. Note that the position of the dashcam 101 may be input from the operation unit 212, but may be input from a mobile terminal or the like via the communication unit 208, in a case where only a limited number of buttons are provided in the operation unit 212 like the present example.

Note that in a case where the attitude of the main body portion 301 is adjusted using an image of the exterior as a reference instead of the vehicle 100, the attitude of the main body portion 301 may deviate from the ideal attitude, unless the vehicle 100 is placed on a horizontal surface. In a case where the attitude of the main body portion 301 deviates from the ideal state, the degree of deviation of the attitude can be estimated and compensated. However, in a case of a smaller deviation of the actual attitude from the ideal attitude, it is possible to compensate the deviation with a higher accuracy. Therefore, it is desirable that the attachment accuracy be higher.

The dashcam 101, which has been attached to the vehicle 100 in this manner, and the attitude of which has been adjusted, is capable of identifying, from the captured image, the position in the three-dimensional space of a target object (or also referred to as an object or an obstacle) included in the image using the position of the camera as a reference. Note that in the present embodiment, inclinations (or rotation angles) around three axes (roll, pitch, and yaw) orthogonal to one another are used for representing the attitude of the main body portion 301. In particular, here, the optical axis is set to a roll axis, the axis of the tilting operation of the camera is set to a pitch axis, and the axis of the panning operation is set to a yaw axis.

### Processing Procedure at the Time of Adjustment

FIG. 4 illustrates an example of processing performed at the time of adjusting the attitude of the dashcam 101. The processing of FIG. 4 may be performed in units of frames when an image is captured by either the front-view camera 101F or the rear-view camera 101R and such an image is displayed. In the present example, first, display of an image captured by the front-view camera 101F will be described. This processing may be performed by the CPU 204 or the image processing unit 203.

First, it is determined whether the current mode is an adjustment mode (S401). The adjustment mode is a mode to be set, for example, after the attachment, when the power button of the operation unit 212 is pressed for the first time and the power is turned on, or when an adjustment button is pressed. In a case where it is determined that the current mode is not the adjustment mode, the captured image may be output without change.

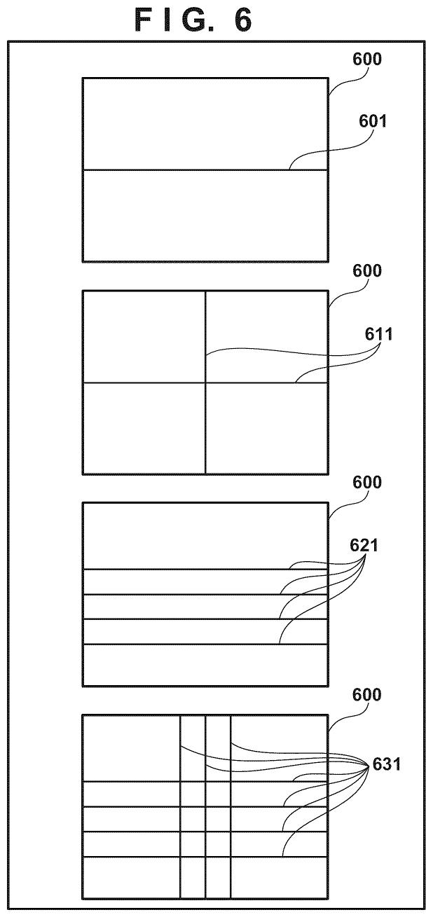

On the other hand, in a case where it is determined that the current mode is the adjustment mode, a first reference image stored beforehand in the erasable ROM 209 is read (S403). The first reference image is an image synthesized with an image captured by the front-view camera 101F, and is referred to by the user so as to adjust the attitude of the main body portion 301. FIG. 6 illustrates its example. In FIG. 6, the first reference image, included in a frame 600, is illustrated. A first reference image 601 is a straight line that passes through the center between the top and the bottom of the frame 600, and that is parallel to upper and lower sides of the frame or the scanning line. The reason why such an image is selected as the first reference image 601 is that by adjusting the attitude of the main body portion 301 so that the first reference image 601 coincides with the sea horizon or the ground horizon, the camera is made to be parallel to the ground surface, and it is considered that the main body portion 301 has been appropriately adjusted for the pitch angle and the roll angle. However, it is assumed that the vehicle 100 is placed on a horizontal surface.

A first reference image 611 illustrates a second example of the first reference image. In the first reference image 611, a straight line that passes through the center of the frame and that is parallel to the left and right sides of the frame is added to the first reference image 601. It is considered that the user who adjusts the attitude of the main body portion 301 is in the vehicle 100. Therefore, assuming that the dashcam 101 is attached to an upper portion of the windshield of the vehicle 100 as illustrated in FIG. 1, the attitude of the main body portion 301 is adjusted so that an object that can be directly seen on a forward side from such a position is aligned on the vertical line of the first reference image 611 on the display. This enables substantially appropriate adjustment also for the yaw angle.

In addition, even though it is not possible to see the sea horizon or the ground horizon, the wall surfaces of buildings are upright vertically in many cases. Therefore, by aligning the wall surface of a building with the vertical line of the first reference image 611 on the image, it becomes possible to appropriately adjust the roll angle.

Such a first reference image is synthesized with the image captured by the front-view camera 101F (S405). The synthesized image is output from the output unit 207, and is then displayed on the display unit 211 (S407). Alternatively, the synthesized image may be output from the communication unit 208 to be displayed on a mobile terminal or the like.

By seeing the first reference image and the scene of the exterior displayed in the above procedure, the user is able to adjust the attitude of the main body portion 301. Note that in the above description, the image of the front-view camera 101F has been described, but such a procedure may be applied to the rear-view camera 101R.

FIG. 5 illustrates a procedure of display processing for adjusting the attitude of the main body portion 301, by using images captured by both the front-view camera 101F and the rear-view camera 101R. This processing is performed by the CPU 204 or the image processing unit 203 in accordance with, for example, an operation on a switch button included in the operation unit 212.

First, it is determined which camera is currently capturing an image for the adjustment (S501). In the case of the rear-view camera 101R, the first reference image is read (S503), and the first reference image is synthesized with the image captured by the front-view camera 101F (S505). Then, the synthesized image is output from the output unit 207 to be displayed on the display unit 211 (S511). Alternatively, the synthesized image may be output from the communication unit 208 to be displayed on a mobile terminal or the like.

On the other hand, in a case where the camera that is currently capturing the image for the adjustment is the front-view camera 101F, a second reference image is read (S507), and the second reference image is synthesized with the image captured by the rear-view camera 101R (S509). Then, the synthesized image is output from the output unit 207 to be displayed on the display unit 211 (S511). In this manner, it becomes possible to adjust the attitude of the main body portion 301 with reference to the image(s) captured by one or both of the cameras.

Here, the second reference image will be described with reference to an example of FIG. 6. Its example is illustrated as a second reference image 621. The second reference image 621 includes a plurality of straight lines parallel to the scanning line of the frame 600. This is for adjusting the attitude of the main body portion 301 with reference to the image of the rear-view camera 101R, for example, when it is not possible to see the sea horizon or the ground horizon on a forward side of the vehicle 100. The interior of the vehicle 100 is partially included in the field of view of the rear-view camera 101R, and in particular, upper portions of backrests of the front seat 102F and the rear seat 102R are captured by the rear-view camera 101R. The vehicle is designed to be substantially symmetric to the left and right except for an instrument panel, a steering wheel, and the like for driving operation, and the front seat 102F and the rear seat 102R are no exceptions. Therefore, the user selects the upper portion of the backrest of a seat or any other vehicle equipment to be horizontal in the interior of the vehicle, and adjusts the main body portion 301 so that the second reference image coincides with a line formed with the vehicle equipment that has been selected. It is needless to say that as for the second reference image, the adjustment may be made using a scene of the exterior of the vehicle that has been captured through the rear window as a reference. Without being limited to the backrest, the adjustment may be made with reference to any vehicle equipment or structure that can be used as the horizontal line.

The reason why the second reference image includes the plurality of straight lines parallel to one another is to enlarge a selection range of the vehicle equipment in the interior of the vehicle 100 to be selected as a reference. For example, in a case where the main body portion 301 is positioned above the backrest of a seat, the difference in distance between the front seat and the rear seat from the camera appears as a difference in image height in the image. If the adjustment is made using an object having an image height different from the horizontal line as a reference by a single line such as the first reference image 601, it would be difficult to correctly adjust the pitch angle, although it is possible to correctly adjust the roll angle. For this reason, a plurality of parallel lines parallel to one another in the horizontal direction are included in the second reference image so as to handle objects respectively having different image heights. By adjusting the attitude with reference to the horizontal line in the second reference image that has been appropriately selected using the vehicle equipment in the interior as a reference, it becomes possible to adjust the attitude using the vehicle as a reference, even though the vehicle 100 is inclined relative to the horizontal surface. In such a case, as to at least the roll angle, deviation due to the attitude of the vehicle hardly occurs. Note that it is desirable that the plurality of lines include a line that passes through the frame center. The line that passes through the frame center may be distinguishable from the other lines, by changing its color or the like. This is because it is possible to use the line also as the first reference image, by adjusting the attitude to align the line with the sea horizon or the ground horizon.

Another example of the second reference image is illustrated as a second reference image 631. The second reference image 631 further includes a plurality of vertical lines orthogonal to the horizontal lines of the second reference image 621. These vertical lines can be used for the same purpose as the vertical line included in the first reference image 611. Furthermore, a plurality of parallel straight lines are included to select and handle the vehicle equipment in the interior of the vehicle. Note that it is desirable that the plurality of vertical lines include a line that passes through the frame center. In such a case, by changing the color of the vertical line that passes through the frame center, it may be distinguishable from the other lines. The attitude can be adjusted so that the line selected from the plurality of lines is aligned with the vertical reference line in the image.

### Effects of Present Embodiment

As described heretofore, when the attitude of the dashcam 101 is adjusted, the reference image is synthesized with the captured image and is then displayed, so that the attitude can be adjusted with high accuracy with reference to such display.

### Modifications

Note that in the present embodiment, the first reference image to be synthesized with the captured image of the front-view camera 101F and the second reference image to be synthesized with the captured image of the rear-view camera 101R are individually prepared. However, the front-view camera 101F and the rear-view camera 101R may use the same reference image. For example, the first reference image 611 or the second reference image 631 may be synthesized with the images captured by both of the cameras, and may be displayed at the time of adjustment. In addition, any reference image other than the reference images illustrated in FIG. 6 may be used. Further, as the second reference image, in a state in which the attitude of the main body portion 301 is adjusted so that the horizontal line captured by the front-view camera 101F coincides with the first reference image 601, a line that coincides with the horizontal line captured by the rear-view camera 101R may be used as the second reference image. With such a configuration, even in a state in which the horizontal line is visually recognizable only by the rear-view camera 101R, the attitude of the main body portion 301 can be adjusted with high accuracy. In addition, by setting the second reference image in this manner, even though the optical axes of the front-view camera 101F and the rear-view camera 101R are not parallel to each other, the attitude of the main body portion 301 can be adjusted by any of the cameras.

Furthermore, in a case where an offset in the width direction of the camera relative to the center in the width direction of the vehicle body is input for the image captured by each of the cameras at the installation time of the dashcam 101, the image may be shifted by such an offset amount, the image may be converted as if the image was captured from the center portion in the width direction of the vehicle, and the reference image may be synthesized with the image. In this case, the directions of the parallel translation in the coordinate system through the conversion are opposite each other between the image captured by the front-view camera 101F and the image captured by the rear-view camera 101R. In the image that has been converted in this manner, the center in the width direction of the image captured by, for example, the front-view camera 101F coincides with the center in the width direction of the vehicle. Therefore, a mark indicating the center of the vehicle is attached to, for example, the hood of the vehicle or a position on a forward side of it and visible to the driver. Then, by adjusting the attitude of the main body portion 301 so that the vertical line of the first reference image 611 is aligned with the mark, it becomes possible to adjust the attitude around the yaw axis with high accuracy.

In addition, in the procedure of FIG. 5, the image of the front-view camera 101F and the image of the rear-view camera 101R are switched and displayed in accordance with the operation, but may be switched and alternately displayed at certain time intervals without necessitating the operation.

### Summary of Embodiments

The present embodiments that have been described heretofore are summarized as follows.
1. An image recording device capable of being retrofitted to a vehicle, the image recording device comprising:
a fixing member configured to be fixed to the vehicle;
a main body fixed to the vehicle by the fixing member;
at least one camera provided in the main body and configured to capture an image in surroundings of the vehicle;
an adjuster configured to adjust an attitude of the main body;
an output unit configured to output the image captured by the at least one camera to a display;
at least one memory storing instructions; and
at least one processor that is in communication with the at least one memory and that, when executing the instructions, cooperates with the at least one memory to execute processing, the processing including
in a case where an adjustment mode is designated, causing the output unit to output another image obtained by synthesizing a reference image with the image captured by the at least one camera, a position of the reference image with respect to a frame of the image being fixed.

This enables adjustment of the attitude of the main body portion with high accuracy while referring to the image.
2. The image recording device according to item 1, wherein
the at least one camera includes a first camera fixed to the image recording device and configured to capture the image of an exterior of the vehicle on a forward side of the vehicle, and
the processing causes the output unit to output, as the reference image, a first image obtained by synthesizing a first reference image with the image captured by the first camera.

This enables referring to the image obtained by synthesizing the captured image on the forward side of the vehicle with the first reference image, and enables adjustment of the attitude of the main body portion based on the image on the forward side.
3. The image recording device according to item 2, wherein
the at least one camera further includes a second camera fixed to the image recording device and configured to capture the image of the exterior of the vehicle on a rearward side of the vehicle through an interior of the vehicle, and
in the case where the adjustment mode is designated, the processing causes the output unit to output, as the reference image, a second image obtained by synthesizing a second reference image with the image captured by the second camera, the second reference image being different from the first reference image.

This enables referring to the image obtained by synthesizing the captured image on the rearward side of the vehicle with the second reference image, and enables adjustment of the attitude of the main body portion based on the image on the rearward side.
4. The image recording device according to item 3, further comprising an operation unit configured to receive an operation, wherein
in the case where the adjustment mode is designated, the processing causes the output unit to output either the first image or the second image in accordance with an operation.

This enables adjustment of the attitude of the main body portion with use of either the image on the forward side or the image on the rearward side of the vehicle.
5. The image recording device according to item 3, wherein
in the case where the adjustment mode is designated, the processing causes the output unit to alternately output the first image or the second image.
This enables adjustment of the attitude of the main body portion with use of both the image on the forward side and the image on the rearward side of the vehicle.
6. The image recording device according to item 1, wherein the reference image includes a straight line along a scanning line of the frame.

This enables adjustment of the attitude of the main body portion with high accuracy for the roll axis.
7. The image recording device according to item 6, wherein the straight line passes through a center of the frame.

This enables adjustment of the attitude of the main body portion with high accuracy for the pitch axis.
8. The image recording device according to item 6, wherein the reference image further includes another straight line orthogonal to the straight line.

This enables adjustment of the attitude of the main body portion with reference to the reference line in the vertical direction.
9. The image recording device according to item 3, wherein the second reference image includes a plurality of parallel straight lines along a scanning line of the frame.

This enables adjustment of the attitude of the main body portion with reference to the interior of the vehicle.

The invention is not limited to the foregoing embodiments, and various variations/changes are possible within the spirit of the invention.

1. An image recording device capable of being retrofitted to a vehicle, the image recording device comprising:
a fixing member configured to be fixed to the vehicle;
a main body fixed to the vehicle by the fixing member;
at least one camera provided in the main body and configured to capture an image in surroundings of the vehicle;
an adjuster configured to adjust an attitude of the main body;
an output unit configured to output the image captured by the at least one camera to a display;
at least one memory storing instructions; and
at least one processor that is in communication with the at least one memory and that, when executing the instructions, cooperates with the at least one memory to execute processing, the processing including
in a case where an adjustment mode is designated, causing the output unit to output another image obtained by synthesizing a reference image with the image captured by the at least one camera, a position of the reference image with respect to a frame of the image being fixed.

2. The image recording device according to claim 1, wherein
the at least one camera includes a first camera fixed to the image recording device and configured to capture the image of an exterior of the vehicle on a forward side of the vehicle, and
the processing causes the output unit to output, as the reference image, a first image obtained by synthesizing a first reference image with the image captured by the first camera.

3. The image recording device according to claim 2, wherein
the at least one camera further includes a second camera fixed to the image recording device and configured to capture the image of the exterior of the vehicle on a rearward side of the vehicle through an interior of the vehicle, and
in the case where the adjustment mode is designated, the processing causes the output unit to output, as the reference image, a second image obtained by synthesizing a second reference image with the image captured by the second camera, the second reference image being different from the first reference image.

4. The image recording device according to claim 3, further comprising an operation unit configured to receive an operation, wherein
in the case where the adjustment mode is designated, the processing causes the output unit to output either the first image or the second image in accordance with an operation.

5. The image recording device according to claim 3, wherein
in the case where the adjustment mode is designated, the processing causes the output unit to alternately output the first image or the second image.

6. The image recording device according to claim 1, wherein the reference image includes a straight line along a scanning line of the frame.

7. The image recording device according to claim 6, wherein the straight line passes through a center of the frame.

8. The image recording device according to claim 6, wherein the reference image further includes another straight line orthogonal to the straight line.

9. The image recording device according to claim 3, wherein the second reference image includes a plurality of parallel straight lines along a scanning line of the frame.

10. A non-transitory computer-readable storage medium storing a program that causes a computer of an image recording device to perform processing, when the program is loaded onto the computer and then executed, the image recording device being capable of being retrofitted to a vehicle, the image recording device including:
a fixing member configured to be fixed to the vehicle;
a main body fixed to the vehicle by the fixing member;
at least one camera provided in the main body and configured to capture an image in surroundings of the vehicle;
an adjuster configured to adjust an attitude of the main body; and
an output unit configured to output the image captured by the at least one camera to a display,
the processing comprising
in a case where an adjustment mode is designated, causing the output unit to output another image obtained by synthesizing a reference image with the image captured by the at least one camera, a position of the reference image with respect to a frame of the image being fixed.
